(19) United States
(12) Patent Application Publication
(10) Pub. No.: US 2026/0326154 A1
(43) Pub. Date: Oct. 22, 2026

(54) CLEANING DEVICE

(71) Applicant: Hong Ann Tool Industries Co., Ltd., Taichung City (TW)

(72) Inventor: Cheng-Wei SU, Taichung City (TW)

(21) Appl. No.: 19/730,493

(22) Filed: Jul. 2, 2026

Related U.S. Application Data
(63) Continuation-in-part of application No. 18/624,581, filed on Apr. 2, 2024.

(30) Foreign Application Priority Data
Jun. 16, 2023 (TW) 112122630

(51) Int. Cl. B08B 1/12

(52) U.S. Cl. CPC B08B 1/12

(57) ABSTRACT

A cleaning device includes a brushing assembly. The brushing assembly includes a holding member configured to be detachably connected to a driving tool, and a brushing member mounted on the holding member. The brushing member has a rough surface for contacting and cleaning a target surface when driven by the driving tool. The cleaning device can be coupled to the driving tool to facilitate cleaning operations and improve cleaning efficiency.

### CROSS-REFERENCE TO RELATED APPLICATIONS

The present application is a continuation-in-part of U.S. patent application Ser. No. 18/624,581, filed on Apr. 2, 2024, now pending, which claims priority to Taiwan Patent Application No. 112122630, filed on Jun. 16, 2023. The entire disclosures of the above applications are incorporated herein by reference in their entirety.

### BACKGROUND OF THE INVENTION

The present invention relates to a cleaning device and, more particularly, to a cleaning device for cleaning the surfaces of tools or parts.

Parts of tools or equipment, when used over a long period, may have issues such as surface rust, rust spots, or accumulated dirt. Most tools or parts can still be used after their surfaces have been cleaned, which avoids the need for replacement. However, traditional cleaning methods involve manually scraping off rust and dirt with tools like screwdrivers or knives, or sanding the surface with abrasive cloth. These methods are not only inefficient but also often result in poor cleaning outcomes and can easily scratch the surface.

Thus, a need exists for a cleaning device to mitigate and/or obviate the above disadvantages.

### SUMMARY OF THE INVENTION

The present invention provides a cleaning device including a brushing assembly. The brushing assembly includes a holding member configured to be detachably connected to a driving tool and a brushing member mounted on the holding member. The brushing member has a rough surface for contacting and cleaning a target surface when driven by the driving tool.

In some embodiments, the holding member is made of a non-metal material. In certain embodiments, the non-metal material is plastic. In further embodiments, the plastic is flexible so that the holding member can elastically deform.

In some embodiments, the holding member is configured to elastically deform to form an interference fit with a receiving hole of the driving tool.

In some embodiments, the holding member includes a head and a body connected to the head, and the brushing member is mounted on the head. Further, the brushing member is bonded to the head. In certain embodiments, the body has a polygonal cross section, and in particular embodiments the polygonal cross section is hexagonal. In certain embodiments, the brushing member has a circular cross section and includes through hole penetrating opposite sides of the brushing member.

The present invention will become clearer in light of the following detailed description of illustrative embodiments of this invention described in connection with the drawings.

### BRIEF DESCRIPTION OF DRAWINGS

FIG. 1 is a perspective view of a cleaning device of an embodiment according to the present invention.

FIG. 2 is an exploded perspective view of the cleaning device of FIG. 1.

FIG. 3 is a cross sectional view of the cleaning device of FIG. 1.

### DETAILED DESCRIPTION OF THE INVENTION

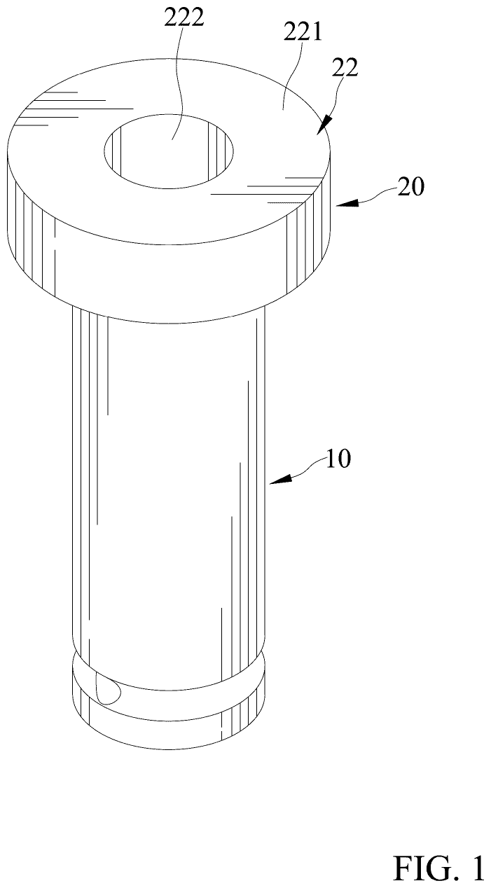

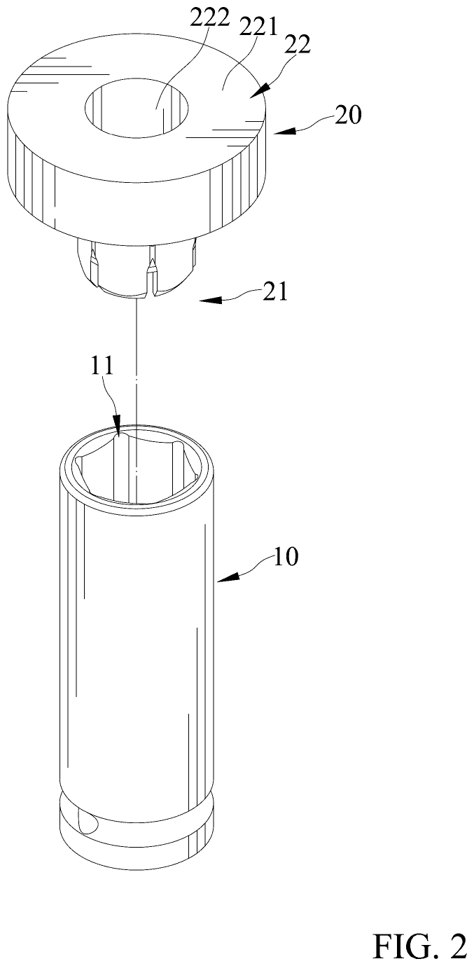

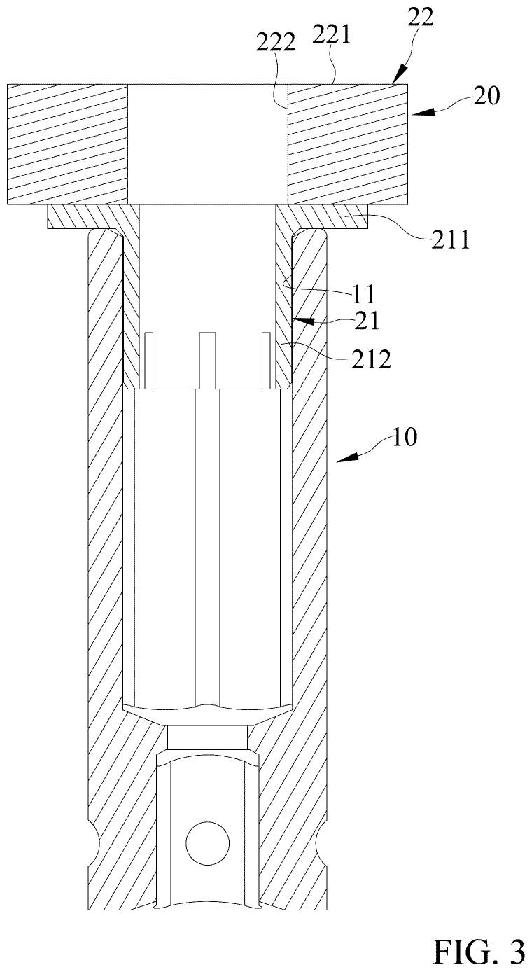

FIGS. 1-3 illustrate a cleaning device according to an embodiment of the present invention. The cleaning device includes a brushing assembly 20. The brushing assembly 20 includes a holding member 21 and a brushing member 22 mounted on the holding member 21.

The holding member 21 is configured to be detachably connected to a driving tool 10. The driving tool 10 may be, for example, a socket. In some embodiments, the driving tool 10 includes a receiving hole 11. The receiving hole 11 may have a polygonal shape, such as a hexagonal shape, for receiving and driving a corresponding portion of the holding member 21.

In certain embodiments, the holding member 21 is made of a non-metal material. In some embodiments, the non-metal material may be plastic. The plastic material may be flexible so that the holding member 21 is capable of elastic deformation. In this manner, when the holding member 21 is inserted into the receiving hole 11 of the driving tool 10, the holding member 21 may elastically deform to form an interference fit with the receiving hole 11, thereby allowing the brushing assembly 20 to be detachably but securely connected to the driving tool 10.

In some embodiments, the holding member 21 includes a head 211 and a body 212 connected to the head 211. The brushing member 22 is mounted on the head 211. Further, the brushing member 22 is bonded to the head 211. The body 212 may be configured to be inserted into the receiving hole 11 of the driving tool 10. In certain embodiments, the body 212 has a polygonal cross section. For example, the body 212 may have a hexagonal cross section so that the body 212 can be engaged with the hexagonal receiving hole 11 of the driving tool 10.

In certain embodiments, the brushing member 22 has a circular cross section and includes a through hole 222 penetrating opposite sides of the brushing member 22.

Through the above structure, the brushing assembly 20 may be connected to the driving tool 10 so that the brushing member 22 can be driven by the driving tool 10 to rotate or move, thereby facilitating cleaning operations and improving cleaning efficiency.

Although specific embodiments have been illustrated and described, numerous modifications and variations are still possible without departing from the scope of the invention. The scope of the invention is limited by the accompanying claims.

1. A cleaning device comprising:
a brushing assembly including:
a holding member configured to be detachably connected to a driving tool; and
a brushing member mounted on the holding member and having a rough surface.

2. The cleaning device of claim 1, wherein the holding member is made of a non-metal material.

3. The cleaning device of claim 2, wherein the non-metal material is plastic.

4. The cleaning device of claim 3, wherein the plastic is flexible.

5. The cleaning device of claim 4, wherein the holding member is configured to elastically deform to form an interference fit with a receiving hole of the driving tool.

6. The cleaning device of claim 4, wherein the holding member includes a head and a body connected to the head, and wherein the brushing member is mounted on the head.

7. The cleaning device of claim 6, wherein the body has a polygonal cross section.

8. The cleaning device of claim 7, wherein the polygonal cross section is hexagonal.

9. The cleaning device of claim 6, wherein the brushing member is bonded to the head.

10. The cleaning device of claim 6, wherein the brushing member has a circular cross section and includes a through hole penetrating opposite sides of the brushing member.
